(19) United States
(12) Patent Application Publication
(10) Pub. No.: US 2009/0188092 A1
(43) Pub. Date: Jul. 30, 2009

(54) Jewelry Mandrel and Method of Using the Same

(76) Inventor: Maciej A. Teresiak, Huntington Valley, PA (US)

Correspondence Address: PAUL AND PAUL, 2000 MARKET STREET, SUITE 2900, PHILADELPHIA, PA, 19103, US

(21) Appl. No.: 12/022,631

(22) Filed: Jan. 30, 2008

(51) Int. Cl. B23P 13/00; A44C 27/00; A45C 11/16

(52) U.S. Cl. 29/8; 29/896.4; 206/6.1

(57) ABSTRACT

A jewelry mandrel having a tapered shaft with an axial groove in the surface of the shaft. The axial groove is capable of accepting one end of a metal wire at a pre-selected location and the depth and width of the groove are sized, such that the metal wire is not generally displaced axially from the pre-selected location as the wire is wound around the perimeter of a cross-section of the shaft.

### FIELD OF THE INVENTION

This invention relates to a device for manufacturing jewelry and a method of using such a device. More particularly, this invention relates to an improved mandrel and method, which can be used by jewelers to fabricate shanks, rings, wedding bands, bangles, or bracelets of various shapes or sizes.

### BACKGROUND OF THE INVENTION

Jewelers often use mandrels to make hoop-shaped pieces or to determine the size of a piece of jewelry, specifically rings. These tools consist of a tapered rod. The length of the rod is graduated and each gradation is marked with a value. The value of each marking typically indicates a whole, quarter, or half size. Ring mandrels are commonly sold in two sizes. Slender ring mandrels are generally provided for ring sizes ranging from one to fifteen and thicker mandrels are provided for sizes ranging from size fourteen to twenty-eight.

The marking on a ring mandrel reflects a ring size such that the circumference of the rod at the location of the marking corresponds to the circumference of a finger having that particular ring size. Mandrels are used to determine the size of a ring by inserting the tip of the rod through the ring and sliding the ring down the rod until the ring is no longer able to slide because the ring reaches a specific point where the inner diameter of the ring is equal to the outer diameter of the tapered rod of the mandrel. The size of the ring is then ascertained by noting the value of the marking at the position of the ring.

Often jewelers fabricate rings or shanks by shaping metal directly on a mandrel. A shank is the round body of the ring that encircles the finger, not including the setting for a precious stone. First, precious metal is rolled or shaped into a wire having any desired cross-section, such as a circle or half-circle. The wire is then wrapped around the mandrel at the marking that corresponds to a desired size. The metal is bent and beaten with a mallet in order to obtain the shape of the cross-section of the mandrel. The excess wire is removed from the ends, and the ends are then soldered together to form a closed ring. The ring is then polished to remove any imperfections in the surface that occur due to the manufacturing process. The most common shape of the cross-section of a mandrel is circular; however, mandrels are also available with a cross-section having various other shapes, such as rectangular, triangular, or oval.

A major drawback to current mandrels is the difficulty in holding a metal wire in place as it is tightly wound around the circumference of the mandrel, so that it is bent into the desired shape. It is important for a piece of jewelry to be sized correctly or the consumer will feel discomfort when wearing the piece because it will either be too tight or too loose. In order to ensure correct sizing and shape of a piece of jewelry which is made with the use of a mandrel, it is important that the metal wire maintains the same position on the shaft of the mandrel as it is wound and shaped. If the metal wire shifts away from the desired location on the mandrel, the resulting piece of jewelry will be either too large or too small and will require additional bending and shaping of the metal. Additional bending and shaping creates more imperfections in the surface of the loop, which ultimately requires additional polishing or surfacing resulting in a loss of precious metal.

It is therefore an object of this invention to provide a mandrel and method of using such a device that enables a user to easily wind a wire of precious metal around the circumference of the mandrel and assist the user in maintaining the position of a metal wire on the shaft of the mandrel while being wound.

### SUMMARY OF THE INVENTION

A mandrel and a method of using a mandrel comprising a shaft having an axial groove capable of accepting one end of a metal wire inserted into the axial groove at a selected position, wherein the axial groove has a width and a depth that prevents the end of the metal wire from generally shifting away for the selected position as the wire is wound around a perimeter of a cross-section of the shaft.

### BRIEF DESCRIPTIONS OF THE DRAWINGS

FIG. 1 is a front elevational view of a mandrel constructed in accordance with the teachings of the present invention;

FIG. 2 is a rear elevational view of a mandrel constructed in accordance with the teachings of the present invention;

FIG. 3 is a cross-sectional view of the embodiment of the present invention shown in FIG. 1, the section being taken generally along the line 3-3 of FIG. 1;

FIG. 4 is the view of the embodiment of the present invention shown in FIG. 3 with one end of a wire inserted into the axial groove of the mandrel;

FIG. 5 is the view of the embodiment of the present invention shown in FIG. 4 as the inserted wire is first bent;

FIG. 6 is the view of the embodiment of the present invention shown in FIG. 4 as the inserted wire is wound three-quarters of the circumference of the cross-section;

FIG. 7 is the view of the embodiment of the present invention shown in FIG. 4 as the inserted wire is wound around the entire circumference of the mandrel;

FIG. 8 is a cross-sectional view of an embodiment of the present invention having a generally oval shape;

FIG. 9 is a cross-sectional view of an embodiment of the present invention having a generally square shape;

FIG. 10 is a cross-sectional view of an embodiment of the present invention having a generally triangular shape;

FIG. 11 is a cross-sectional view of an embodiment of the present invention having a generally rectangular shape;

FIG. 12 is a cross-sectional view of an embodiment of the present invention having a generally tear-drop shape; and

FIG. 13 is a cross-sectional view of an embodiment of the present invention having a generally octagonal shape.

### DETAILED DESCRIPTION OF THE INVENTION

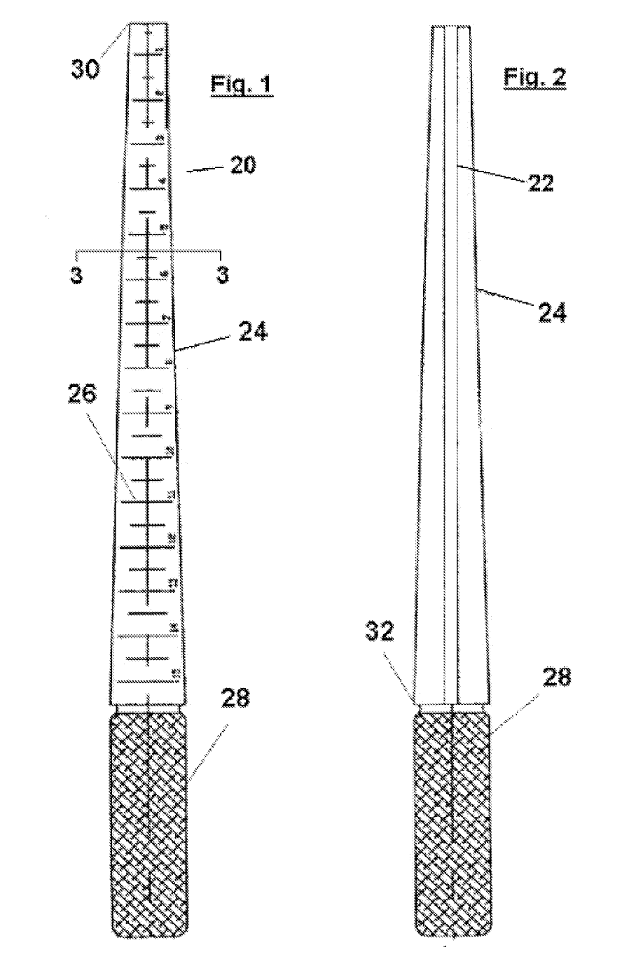

Referring first to FIG. 1, a front elevational view of a mandrel constructed in accordance with the teachings of the present invention may now be seen. The mandrel 20 comprises a shaft 24 in which the diameter of the shaft 24 increases from the tip 30 to the opposite end at which there is a handle 28 having a generally cylindrical shape. The mandrel 20 may be made of any rigid material, preferably steel, and is also preferably manufactured as a single unitary piece. The present invention is not limited to a shaft which is tapered, but may also be comprised of a shaft having a uniform thickness, which is advantageous for a user that prefers to fabricate multiple loops of the same size on a single mandrel. For tapered mandrels, the surface of the shaft 24 is divided into several gradations 26. In the embodiment of FIGS. 1 and 2, the scale ranges from a size of one to fifteen that is further divided into subdivisions of halves; however, the present invention is not limited to a particular range or number of subdivisions.

Referring next to FIG. 2, a rear elevational view of the mandrel shown in FIG. 1 may now be seen. Along the length of the shaft 24 is an axial groove 22. The groove 22 preferably traverses the entire length of the shaft 24 from the tip 30 to the opposite end 32, which is located just above the handle 28. A continuous axial groove spanning the length the shaft 24 is preferred, so that a piece of metal wire which is inserted into the groove can be wrapped around the perimeter of a cross-section of the shaft on a plane which may be in between the divisions or subdivisions marked on the scale. This will enable the fabrication of a ring for a customer having a ring size that is in between a whole or half-size. The present invention is not limited to the placement of the divisions or markings to the opposite side of the shaft 24 from the groove 22. The labels and gradations identifying the values on the scale could also be placed adjacent to the axial groove 22.

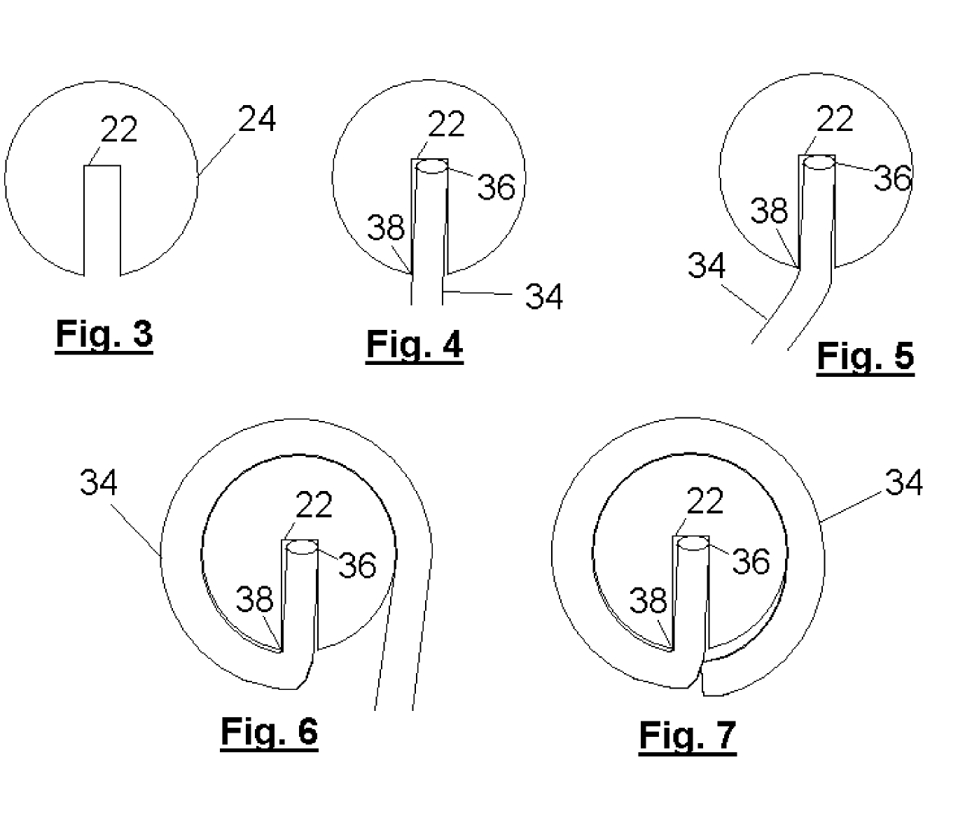

Referring next to FIGS. 3 through 7, a cross-sectional view of the embodiment in FIG. 1, generally along line 3-3 may now be seen. Closed loops are commonly produced during jewelry making for pieces, such as rings, bracelets, or earrings. Open loops are commonly produced for chain links or shanks that will later have a setting inserted into the gap of the loop. The loops of bent metal typically begin as wire made of various types of any precious metals, such as gold or silver, that can be shaped and also comes in a variety of thicknesses that is measured in the United States in units of gauge. The thickness of the metal wire used depends on the type of jewelry that is being fabricated. For example, metal wire used to fabricate a ring is generally 10 to 16 gauge. Because metal wire is produced in various thicknesses, it is important that the axial groove 22 is wide enough to accommodate the thickness of the metal wire. The depth of the axial groove 22 is also important. When an end of metal wire 34 is inserted into the axial groove 22 and wound around the perimeter of the cross-section of the shaft 24, the metal wire 34 will contact the axial groove 22 at a first point 36 and a second point 38. If the axial groove 22 is too shallow, winding the metal wire around the shaft 24 of the mandrel, for example in a clockwise direction as depicted in FIGS. 3-7, the end of the metal wire 34 will lift out of the groove 22 because the wire acts as a lever with its fulcrum occurring at the second point 38. When the axial groove 22 is sufficiently deep, the wire will butt against the inner wall of the groove 22 at the first point 36 and the wire will bend at second point 38 as it is wound around the perimeter of the cross-section of the mandrel. The force of the wire against the inner wall of the axial groove 22 at the first point 36 will also prevent the wire from displacing axially within the groove 22. This ensures that the resulting metal loop will have the intended size as selected by the user when the end of the metal wire 34 was first inserted into the axial groove 22. It is preferred that the width of the groove is fixed and uniform throughout the length of the axial groove, so that the ability of the groove to retain a metal wire is consistent at every point along the shaft of the mandrel.

Prior to shaping a loop with the present invention, the metal wire must be clean, free of solder and optionally rolled and shaped into any desired shape. The metal wire is then heated so that the metal becomes malleable and easily shaped. Upon reaching this temperature the metal is allowed to cool slowly to retain its malleable properties. This process is known as annealing. Once annealed, a user selects the position on the mandrel corresponding to the desired size of the loop and inserts the end of the metal wire into the axial groove at a location that shares the same plane with the desired size. This plane is perpendicular to the center axis of the mandrel. The metal wire is then wound in either direction against the perimeter of the cross-section of the mandrel through which the selected position passes, so that the metal wire takes on the shape of the perimeter. By winding the metal wire around a cross-section that is perpendicular to the center axis of the shaft 24, the user ensures that the resulting loop will have the desired size, which was initially selected.

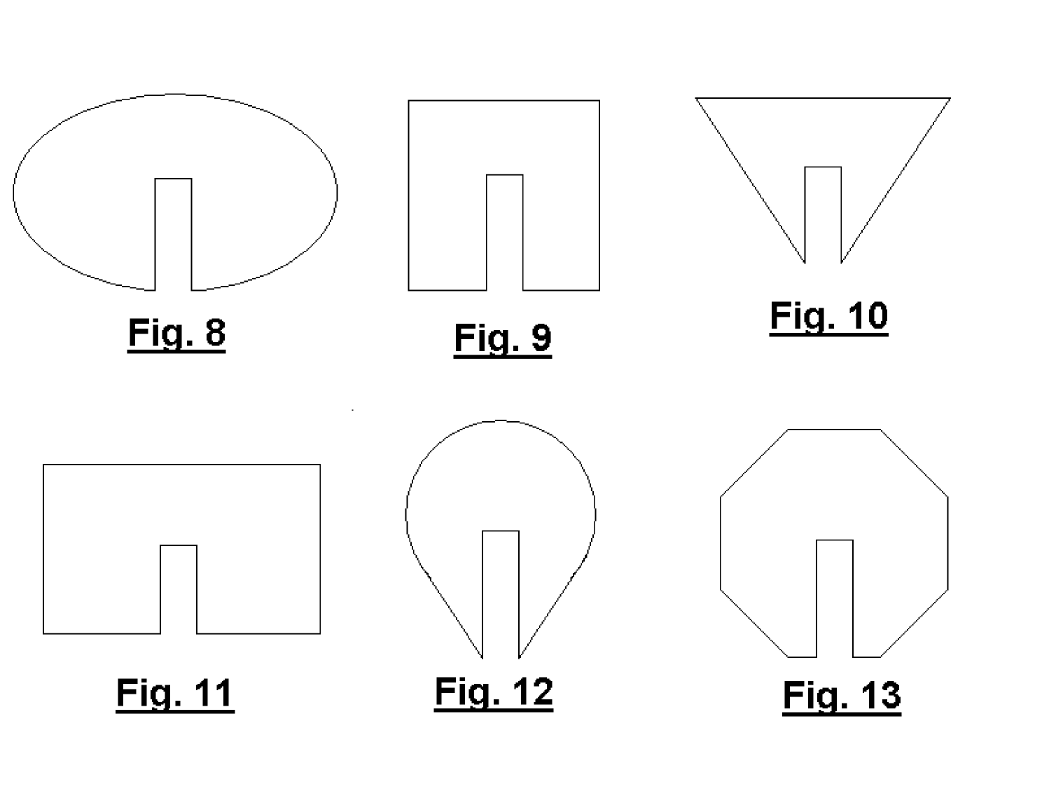

Referring now to FIGS. 8 through 13, a cross-sectional view of various embodiments of the present invention may now be seen. The present invention is not limited to a single shape for the perimeter of the cross-section of the mandrel. Circular cross-sections are desirable for rings, but other shapes such as triangles or teardrops may be preferable when fabricating loops for earrings, bracelets, or as settings for precious stones. In order to further facilitate the ease in which a metal wire can be bent and formed into a loop by using the present invention, the groove in a particularly shaped mandrel must be placed in a specific location. For example, the groove in the triangle shaped mandrel in FIG. 10 and the teardrop shaped mandrel in FIG. 12 is located along the point of the shapes. Placing the groove along the point of the triangle is advantageous because it will enable a user to press the metal wire against all three sides of the triangle without the risk of overlapping the ends of the wire or forcing the user to deviate from the plane which is perpendicular to the center axis to complete the loop. Placing the groove along the point of the teardrop allows the user to avoid bending the wire around a sharp point to complete the loop, which is more difficult than bending the wire along the round end of the teardrop shape.

Thus, there has been described and illustrated herein a mandrel and method of using a mandrel that enables a user to easily bend a metal wire of precious metal around the circumference of the mandrel and assist the user in maintaining the position of a metal wire on the shaft of the mandrel while being wound. However, those skilled in the art will recognize that many modifications and variations besides those mentioned specifically may be made in the technique described herein without departing substantially from the spirit and scope of the present invention. Accordingly, it should be clearly understood that the form of the invention described herein is exemplary only, and is not intended as a limitation on the scope of the present invention.

What is claimed is:

1. A jewelry mandrel comprising a shaft having an axial groove capable of accepting one end of a metal wire inserted into the axial groove at a pre-selected position, wherein the axial groove has a width and a depth that prevents the end of the metal wire from lifting out of the axial groove and prevents the end of the metal wire from axial displacement from the pre-selected position as the wire is wound against a perimeter of a cross-section of the shaft.

2. The jewelry mandrel of claim 1, wherein the shaft is tapered.

3. The jewelry mandrel of claim 1, wherein the shaft has a tip and a base and the axial groove spans the shaft from the tip to the base.

4. The jewelry mandrel of claim 1, wherein the shaft has a center axis and the cross-section of the shaft is perpendicular to the center axis.

5. The jewelry mandrel of claim 1, wherein the jewelry mandrel is in the form of a single unitary structure.

6. The jewelry mandrel of claim 1, wherein the width of the axial groove is fixed.

7. The jewelry mandrel of claim 1, wherein the length of the axial groove is fixed.

8. The jewelry mandrel of claim 1, wherein the shaft has a base and the jewelry mandrel further comprises a handle fixedly attached to the base.

9. A jewelry mandrel comprising:
a tapered shaft having a tip, a base, a center axis, and an axial groove that spans the shaft from the tip to the base; and
a handle fixedly attached to the base of the shaft;
wherein the axial groove is capable of accepting one end of a metal wire inserted into the axial groove at a pre-selected position, wherein the axial groove has a depth and a fixed width that prevents the end of the metal wire from lifting out of the axial groove and prevents the end of the metal wire from axial displacement from the pre-selected position as the wire is wound against a perimeter of a cross-section of the shaft that is perpendicular to the center axis; and
wherein, the jewelry mandrel is of one-piece construction.

10. A method of shaping a metal wire into a loop, said method comprising:
providing metal wire having at least one end;
selecting a location on a shaft of a mandrel having an axial groove, wherein the axial groove has a width and depth that prevents the at least one end of the metal wire from lifting out of the axial groove and prevents the at least one end of the metal wire from axial displacement from the selected location during formation of the loop;
inserting the at least one end of the metal wire into the axial groove of the mandrel; and
winding the metal wire against a perimeter of a cross-section of the shaft.

11. The method of claim 10, wherein the step of providing a metal wire includes annealing the metal wire.

12. The method of claim 11, wherein the shaft has a center axis and the cross-section of the shaft against which the metal wire is wound is perpendicular to the center axis.
